(19) United States
(12) Patent Application Publication
(10) Pub. No.: US 2014/0128023 A1
(43) Pub. Date: May 8, 2014

(54) APPARATUS FOR DISPENSING RENTED WIRELESS DEVICES FOR INTERNET ACCESS VIA A LOCAL AREA NETWORK (LAN)

(71) Applicant: Benjamin Guerra, South Provo, UT (US)

(72) Inventor: Benjamin Guerra, South Provo, UT (US)

(21) Appl. No.: 13/672,665

(22) Filed: Nov. 8, 2012

(51) Int. Cl. H04W 4/24; H04W 60/00

(52) U.S. Cl. CPC H04W 4/24; H04W 60/00
USPC 455/406; 455/435.1

(57) ABSTRACT

A method, apparatus, computer program product and system are disclosed for dispensing rented wireless devices to commercial customer, such as tablet computers, iPhones®, Androids®, and the like from a mobile kiosk interconnected with the Internet and a LAN. The kiosk functions in part as a server and houses a plurality of wireless devices which are dispensed automatically upon payment of a fee and deposit in accordance with a predetermined fee criteria, and are returned by customers after use.

### BACKGROUND OF THE INVENTION

1. Field of the Invention

This invention relates to wireless routers, and more specifically relates to an enterprise apparatus, system and method for leasing and dispensing wireless computers interconnected on a LAN in commercial areas.

2. Description of the Related Art

Wireless devices are well-known to those of skill in the art. These devices often communicate on local area networks (LANs) or wide area networks (WANs) using variations of TCP/IP protocols with routers, wireless switches, servers and the like. These wireless devices include cellular phones, laptop computers, tablet computers (such as Apple iPads®) and other devices known to those of skill in the art. Municipalities, family members, consumers, business travelers, soldiers, and commercial establishments the world over communicate on the Internet using these wireless devices. These entities exchange digital media, such as movies, music, photographs, as well as email, hyper-text and documents in their intercommunication one with another.

It is common for business travelers, military personnel, and the like to carry cumbersome laptop computers for the purpose of connecting to various LANs in airports, commercial centers, and residences while on the move. Restrictions on luggage size imposed upon these individuals by airlines, employers, retail pricing, and/or the reality of an individual's need to carry other items with them can make the constant ownership and possession of a wireless device impractical. Invariably, even those individuals constantly carrying wireless devices can forget them from time-to-time.

These individuals are often in need of access to wireless devices and wireless Internet connections in airports and other locales, and the inability of these individuals to use these devices to communicate with family members, employers, and loved ones can be a source of stress and frustration.

Because of the numbers and magnitude of individuals needing access to wireless devices and wireless networks; machines and systems which rent and dispense wireless devices are needed. Essential to a large market share and the success of any family of devices implemented would be the ability of customers making use of the devices to return the devices to machines in different locations after travel, and the ability of individuals to have cost-effective access to portable, unsecured machines they can use at their leisure during down time. If there are many competing systems, returning wireless devices would be difficult as would the cost of mounting deposits for the machines with multiple services.

### SUMMARY OF THE INVENTION

From the foregoing discussion, it should be apparent that a need exists for a device and system for dispensing rented wireless devices. The present invention has been developed in response to the present state of the art; and, in particular, in response to the problems and needs in the art that have not yet been fully solved by currently available methods, systems and apparatus, and that overcome many or all of the above-discussed shortcomings in the art.

Accordingly, the present invention has been developed to provide a device for dispensing rented wireless devices to customers, the device comprising: a housing securely enclosing operational electronic components of the device during unattended operation in a commercial setting; a graphical user interface (GUI or “display”) for interfacing with a customer; one of an internal shelf and a carrousel for housing wireless devices in logical connection with a local area network (LAN); a wireless router for facilitating network communication and relaying encrypted TCP/IP packets to the wireless devices on the LAN, the wireless router connected to, and identified by, an IP address on the Internet; an electromechanical dispenser for dispensing wireless devices to customers; an electromechanical retriever for receiving wireless devices returned by a customer to the device; a plurality of dispensable wireless devices housed within the housing; a card swipe for scanning credit cards of customers; a processor; and a data storage means for storing data.

The apparatus may further comprise pushbutton controls for customer interface with the device. The apparatus may comprise a kiosk. The apparatus may further comprise signage for advertising features and pricing to potential customers.

In some embodiments, the apparatus further comprises: a database server comprising a processor and a memory device, the database server configured to store executable and operational data, the memory device comprising: an registration module configured to registered a customer into a virtual structure controlled by a central authority; an accessor module configured to electronically access registration information for a customer via the Internet, said registration information accessible only through a grant of permission of from a central authority, said registration information structured in one or more computer readable files and comprising all of name, email, payment information, and historical history evidencing wireless devices previously rented; a payment module configured to accept electronic payment of the override; a dispenser module configured to dispense the wireless device the customer and record in computer readable memory one or more of: the serial number of the rented wireless device, the MAC address of the rented wireless device, and the IP address of the rented wireless device; a retriever module configured to retrieve a wireless device inserted by the customer into the retriever, and to verify the wireless device retrieved is the wireless device previously dispensed to the customer and that the retrieved wireless device is in good working condition; a transmitter module configured to transmit notice of the rental by the customer to the central authority.

The apparatus may further comprise a communication module configured to email third-parties employers of the customer with invoicing and promotional information. In some embodiments, the fees charged to the customer are commiserate with the credit rating of the customer. The housing may be affixed to a plurality of a casters on its undersurface.

A system to dispense and retrieve rented wireless devices is also disclosed, the system comprising: a processor; a data storage means for storing data; a relational database management system (RDBMS); a GUI; a plurality of wireless devices housing within a housing comprising the RDBMS and processor; an registration module configured to registered a customer into a virtual structure controlled by a central authority; an accessor module configured to electronically access registration information for a customer via the Internet, said registration information accessible only through a grant of permission of from a central authority, said registration information structured in one or more computer readable files and comprising all of name, email, payment information, and historical history evidencing wireless devices previously rented; a payment module configured to accept electronic payment of the override; a dispenser module configured to dispense the wireless device the customer and record in computer readable memory one or more of: the serial number of the rented wireless device, the MAC address of the rented wireless device, and the IP address of the rented wireless device; a retriever module configured to retrieve a wireless device inserted by the customer into the retriever, and to verify the wireless device retrieved is the wireless device previously dispensed to the customer and that the retrieved wireless device is in good working condition; a transmitter module configured to transmit notice of the rental by the customer to the central authority.

The customers may preregister for use of the device on a website maintained by the central authority before interfacing with the device.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an upper perspective view of an apparatus for dispensing rented wireless devices in accordance with the present invention;

FIG. 2 is a data-flow diagram illustrating dataflow between members of an interactive business enterprise system involving rented wireless devices in accordance with the present invention;

FIG. 3 is a flowchart illustrating steps of a method of renting wireless devices in accordance with the present invention;

FIG. 4 is a system-flow diagram illustrating dataflow between interworking members of a system for renting wireless devices in accordance with the present invention;

FIG. 5 is a block diagram illustrating one embodiment of an apparatus for dispensing rented wireless devices for Internet access on a LAN in accordance with the present invention;

FIG. 6 is a flowchart illustrating steps of a method for dispensing rented wireless devices in accordance with the present invention;

FIG. 7 is a top perspective view of an internal carousel for warehousing and dispensing wireless devices in accordance with the present invention; and

FIG. 8 is an upper perspective view of a roller for warehousing and dispensing wireless in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

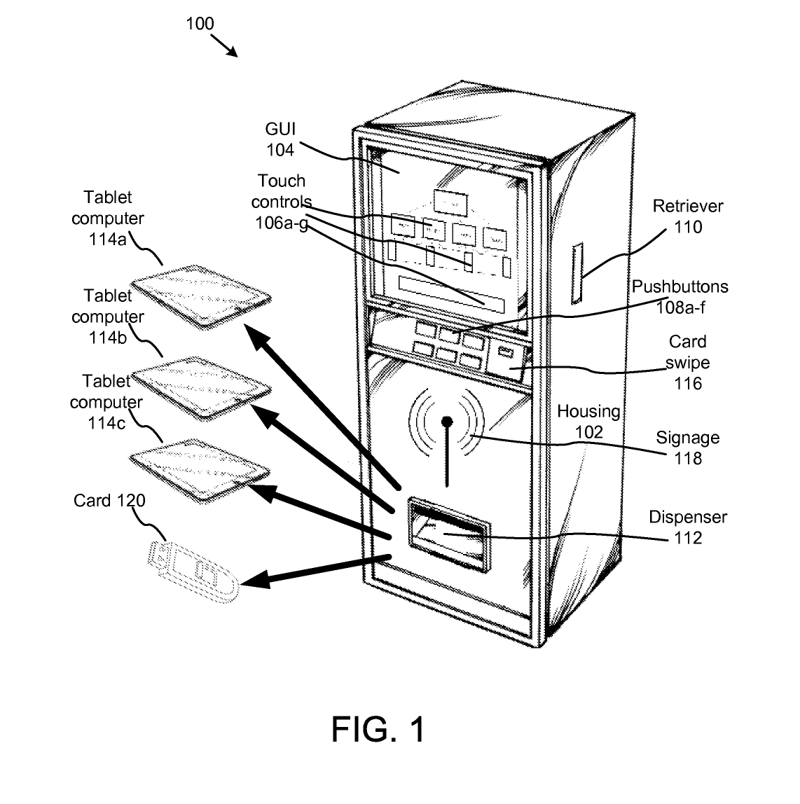

FIG. 1 is an upper perspective view of an apparatus for dispensing rented wireless devices in accordance with the present invention. The apparatus 100 comprises a housing 102, a GUI 104, touch controls 106a-g, push buttons 108a-f, a wireless device return 110, a dispenser 112, a tablet computer 114a, tablet computer 114b, a tablet computer 114c, a card swipe 116, signage 118, and a card 120.

Customers desiring to rent wireless devices, such as a tablet computer 114, a laptop, and the like, interact with the apparatus 100 using the touch controls 106a-g on the GUI touch screen 104. The customers may comprise any person, company or organization needing to communicate in any fashion on a LAN or WAN, or the Internet.

Before these customers can rent and receive a wireless device 114, they must register with the apparatus 100. For the purposes of this disclosure, the term “register” denotes the act of formally registering and being approved to rent wireless devices 114. The registration process involves accepting input from the customer via the GUI touch screen 104. In various embodiments, the customer is prompted to enter his/her name, social security number, address, telephone number, email, and the like. The apparatus 100 may be configured to automatically run a credit check on the customer and adjust fees for renting in accordance with the credit rating of the customer.

In various embodiments, the customer may also be prompted for one or more of the following: age, address, gender, income, education, reason for renting from a pre-populated list, and operating system and architecture preferences.

The commerce architecture involving the machine 100 includes a central authority. The central authority may comprise any individual, company, organization, or plurality of individuals, companies and organization, which runs the machine 100, which sets standards for approval of registration of a user, and may authorize a registered use to rent devices 114 from the apparatus 100.

The apparatus 100 and the tablet computers 114a-c comprise computer programs running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In the present invention, the apparatus 100 wirelessly routes TCP/IP packets to and from one or more servers to which the machine 100 is connected via a WAN. The device 100 is likewise wireless connected to the wireless devices 114 rented to the customer/user. The wireless device 114 may be programmed with a browser for rendering the TCP/IP packets.

The device 100 comprises a router and may comprise a relational database management system (RDBMS) or a database management system (DBMS), such as Oracle, DB2, Firebird, SQL, or other DBMSs as well-known to those of skill in the art, for querying a central database and retrieving registration information for customers who have already registered who need to rent a wireless device 114. In typical embodiments, the registration information is stored in a database(s) by programs well-known to those of skill in the art, such Microsoft Outlook, Thunderbird, Yahoo! Mail, and the like.

The machine 100 is managed by a central authority over a distributed network, which central authority may be a for-profit corporation or legal entity. In various embodiments, the central authority is in exclusive logical communication with the machine through a networked environment, such as local area network (LAN) or wide area network (WAN), or the Internet, for reviewing sales statistics and configuring machine 100 settings.

The machine 100 transmits data back-and-forth between the machine 100, servers on the Internet, and the wireless devices 114a-c.

The machine 100 charges customers one or more of a deposit and a fee to rent wireless device 114 from the machine 100. These payments are compulsory before the wireless device 114 can be dispensed. In various embodiments, the Machine accepts payments via electronic means well-known to those of skill in the art, including PayPal®, credit-card credits, direct bank deposits, eCheck, and the like. The amount of the payment may be determined in accordance with a predetermined payment criteria, or may vary with the credit rating and deposit amount of a user.

The registration information of registered customers is stored in a computer readable file written in computer readable storage accessible by the machine 100, usually a relational computer database. The member structure comprises a structured computer-readable file, but may also comprise a book, audio recording, video, digital image, or the like. The member structure is referenced and registration confirmed by the machine before any wireless devices 114 are rented and dispensed.

In the shown embodiment, the commerce architecture comprises an expenses record, which is a computer readable file written in computer readable storage which is periodically relayed via email to an email account in each customer's registration information.

The Internet is well-known to those of skill in the art. The Internet comprises a collection of interconnected computers and computer networks linked by ethernet cables, wireless connections, and the like, such as the world-wide-web.

The machine 100 comprises a retriever 110 which comprises a slot in the housing 102 and an electronically activated door. In various embodiments, the customer is prompted by the machine 100 on the GUI 104 to indicate that the customer is going to return a rented wireless device 114. The door on the retriever 110 is then opened electronically, and the wireless device 114 returned into the retriever 110.

In various embodiments, the apparatus 100 comprises an internal carousel having a plurality of shelves axially rotating a center shaft. An empty shelf is rotated into position behind the retriever internally for receiving the wireless device 114 returned by the customer.

In some embodiments, the customer is prompted to manually plug a USB cord into a port on the wireless device 114 before the return is logged and finalized by the apparatus 100. In other embodiments, a human operator acting remotely using a DPD on a LAN and/or a WAN accesses a remote desktop on the returned wireless device 114 and erases data and reconfigured settings imposed upon the wireless device 114 by the customer. In still further embodiments, the apparatus 100, using the internal router, is configured to automatically restore default settings to the wireless device 114 after it is returned using administrative account access to the operating system on the wireless device 114.

In some embodiments, the apparatus 100 comprises internal shelving on a track which rises and falls to put into position behind the retriever 110 an empty shelf for receiving a returned wireless device 114.

In some embodiments of the present invention, a wireless device 114 is dispenses from the apparatus 100 without persistent memory or an operating system installed. A disposable flash memory card 120, a firmware card, or a ROM card is then dispensed separately by the machine 100, which card 120 is detachably inserted into the wireless device 114. This card 120, in some embodiments, comprises the operating system necessary to run the machine. In other embodiments, the card 120 comprises a unique identifier in persistent memory which quantifies the amount of time which has been authorized the customer to use the rented wireless device 114. The customer may be forced to prepay for predetermined interval of time at the apparatus 100, which time is stored on the card 120. The wireless device 114 may be configured, in firmware, hardware, or with software, to automatically disable itself after the prepaid interval of time has passed. In those embodiments, all data, downloads, files and the like saved by the customer are saved to the card 12-. The card 120 is disposable, and the customer permitted to keep the card 120 with saved data after returned the device. In this manner, the need to restore default settings and handle document deletion, is obviated because the customer takes the card 120 with him/her, and a subsequent customer inserts a new card 120 into the machine for subsequent usage.

In various embodiments, a customer is prompted when rented a wireless device 114 through the GUI to select versions of software applications which the customer would like installed on the card 120 and available for use on the wireless device 114 during the rental period. These applications may then be copied onto the card 120 by the apparatus, and the card 120 inserted into the wireless device 114 via a USB port or other means known to those of skill in the art.

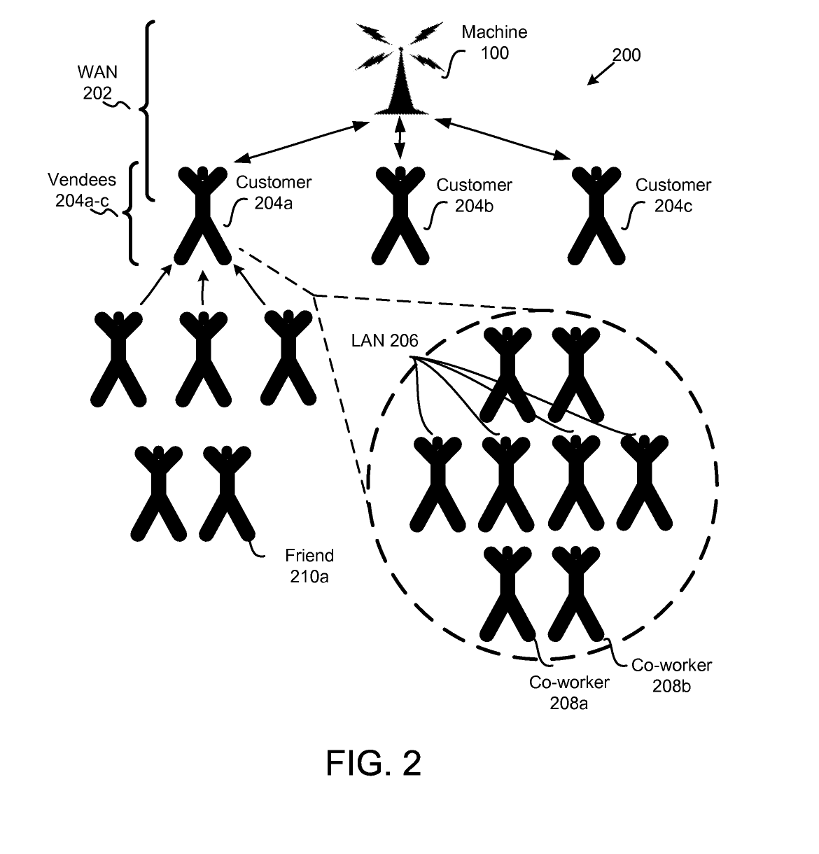

FIG. 2 is a data-flow diagram illustrating dataflow between members 200 of an interactive business enterprise system involving rented wireless devices in accordance with the present invention. The members comprise the machine 110, customers 204a-c, a friend 210, a WAN 202, and a LAN 206.

The customers 204a-c have rented wireless devices 114 from the machine 100. The customers 204a-c may use the wireless device 114 to communicate with coworkers 208a-b on a LAN 206, or may exchange digital media with friends 210 on the WAN 202.

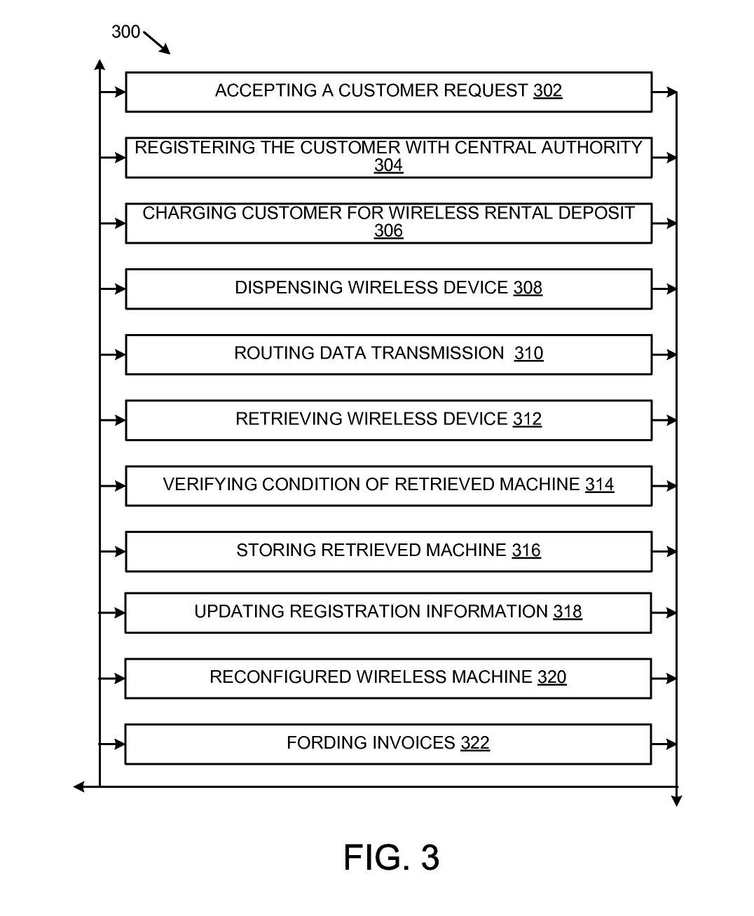

FIG. 3 is a flowchart illustrating steps of a method 300 of renting wireless devices in accordance with the present invention. The method 300 begins when a customer 204 approaches the machine 100 and touches 302 the touch screen 104. The customer is prompted by the machine 100 to input registration information and to register 304 with the central authority managing the machine 100.

The method 300 proceeds, and the customer 204 is charged 306 for use of a wireless device 114 which is subsequently dispensed 308. In some embodiments, a card 120 is also dispensed. Customer communications between the wireless device 114 and the machine 100 are handled 310 by a wireless router forming part of the machine 100.

Once the customer 204 has finished using the wireless device 114, the customer 204 returns the wireless device 114 to the machine 100. The machine 114 retrieves the wireless device 114 through a slot in the housing 102. The wireless device 114 is returned to one of a carousel and a roller housed with the machine 100. After the wireless device 114 is returned, it is charged by a power supply within the machine 100 in some embodiments, its original default operating settings are restored, and data saved to the memory of the wireless device is charged using inductive charging.

The device 100 may be configured to verify 314 the external condition of the machine by doing a thermoimaging scan of the exterior shell of the wireless device 100. In other embodiments, the device 100 verifies 314 computer applications and internal memory has not been tampered with.

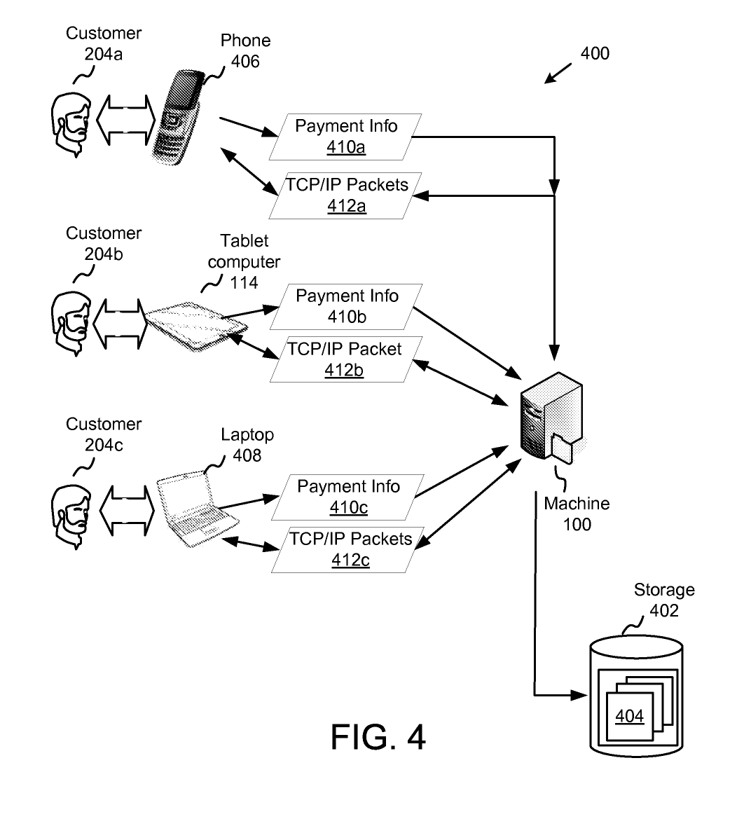

FIG. 4 is a system-flow diagram illustrating dataflow 400 between interworking members of a system for renting wireless devices in accordance with the present invention. The dataflow 400, data and members comprise a machine 100, storage 402, a database 404, a phone 406, a tablet computer 114, a laptop 408, customer 204a-c, payment information 410a-c, and TCP/IP packets 412a-c.

Each of these components, data and members are well-known to those of skill in the art. Data flows between each of the labeled items in the diagram as shown. In some embodiments, all actions made by customers 204a-c are logged in persistent storage 404, along with the payment information 410a-c sent by the customers 204a-c.

The commerce architecture comprises customers, the machine 100, and the central authority.

The storage 402 may be under the control of the central managing authority.

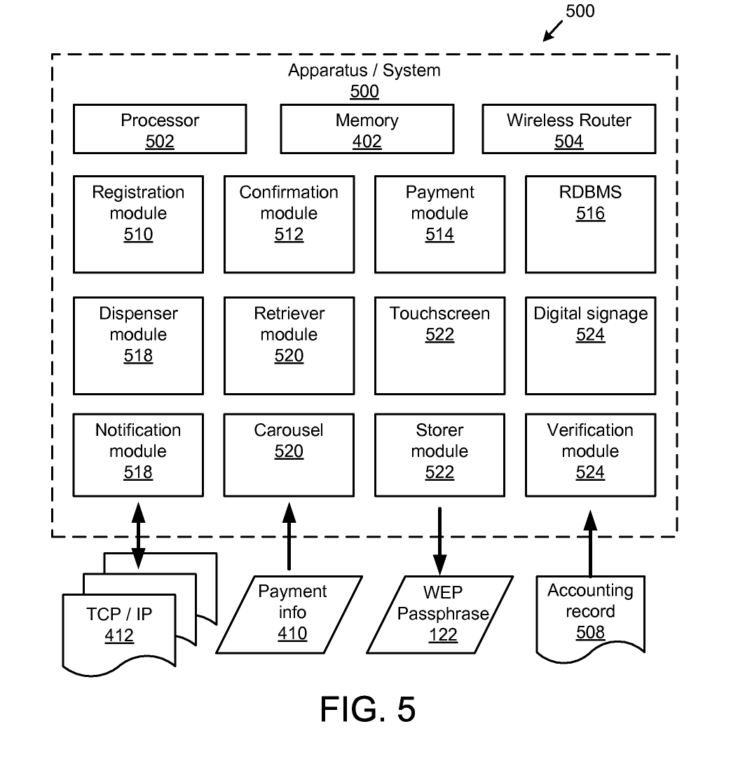

FIG. 5 is a block diagram illustrating one embodiment of an apparatus for dispensing rented wireless devices for Internet access on a LAN in accordance with the present invention. The apparatus/system 500 includes various modules as shown and also comprises a database server comprising a memory device and configured to store executable and operational data.

The registration module 510, in the shown embodiment, is configured to accept registration information 410 from customers input via the GUI 104 or other interfacing means. The registration module 510 may comprise the hardware, software and/or firmware necessary to read block storage or content-addressable storage as will be recognizable to those of skill in the art. In some embodiments, the registration module 510 accepts and stores all information provided by customers to the machine 100, including the registration information 410 substantially described above.

In some embodiments of the present invention, the apparatus 200 includes an accessor module (not shown) for accessing the member structure. The accessor module may comprise the hardware, software and/or firmware necessary to read block storage or content-addressable storage as will be recognizable to those of skill in the art.

In some embodiments of the present invention, the apparatus 100 includes a storer module 522. The storer module 522 stores the customer registration information in persistent storage to which the machine 100 has access. The storer module 522 may comprise a peripheral device which is internal or external to housing 102, such as a disk-drive, or card 120.

In some embodiments of the present invention, the apparatus 100 includes a payment module 514. The payment module 514 bills customers an amount of money determined in accordance with the predetermined commission criteria. The payment module 514 may be configured is configured to accept electronic payments of money in amounts specified by the charger module and/or the predetermined commission criteria using means well-known to those of skill in the art.

The notification module 518, in the shown embodiment, sends receipts, invoices, and financial statements to customers 204 making use of a machine 100. The notification module 518 may automatically transmit these via email using variations of the Simple Mail Transfer Protocol (SMTP), Internet Message Access Protocol (IMAP), Post Office Protocol (POP), or other protocols well-known to those of skill in the art.

The verification module 524 may verify the condition of internal memory or the exterior shell of a wireless device 114.

The carousel 520 is substantially described below.

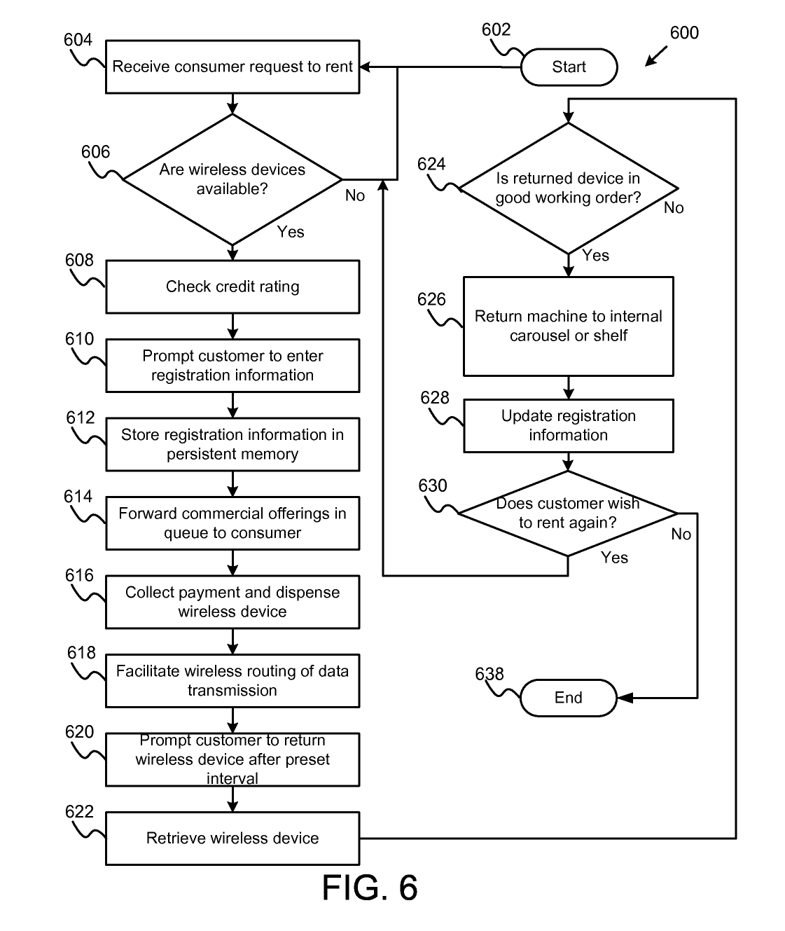

Referring now to FIG. 6 is a flowchart illustrating steps of a method for dispensing rented wireless devices in accordance with the present invention. The method 600 proceeds as shown, and may be executed by the apparatus 100, and computer readable instructions configuring the apparatus 100 stored in computer readable memory 404.

When a customer requests 604 a wireless device 114, the machine 100 first checks 606 to see if any wireless devices 114 (including smart phones 406 and laptops 408) are available for dispensing.

They wireless devices 114 are available for dispensing, the customer's credit rating is checked 608 using means known to those of skill in the art, and the customer is prompted 610 to continue the registration process and pay for a wireless device 114 rental. In various embodiments of the present invention, the customer is first prompted 614 to respond to one or more commercial offerings, or advertisements, digitally displayed to the customer on the GUI before a wireless device 114 is dispensed.

Wireless devices 114 are returned 626 into a slot on the device 100. Before being warehoused on a carousel or roller, they are checked to verify 624 good working condition.

Finally, the customer may be prompted rent another wireless device 114 after returning the previously rented wireless device 114.

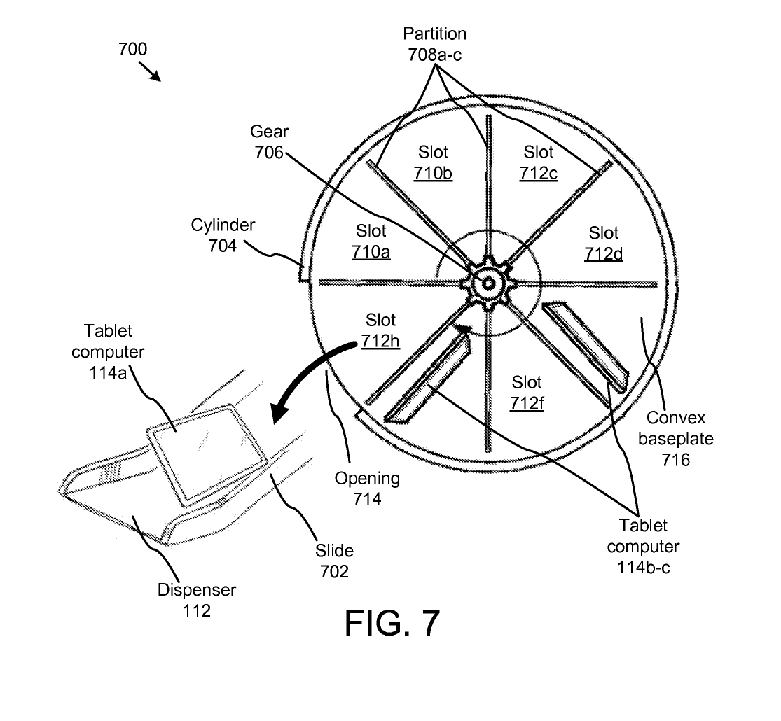

FIG. 7 is a top perspective view of an internal carousel 700 for warehousing and dispensing wireless devices in accordance with the present invention. The carousel 700 comprises a cylinder 704, a gear 706, partitions 708a-c, slots 712a-h, a convex baseplate 716, a slide 702, a dispenser 112, and tablet computers 114a-c.

The carousel 700 is internal to the device 100. The carousel 700 warehouses wireless devices 114 until dispensing them in response to an electronic instruction of a DPD. In some embodiments, this DPD is the wireless router 504 or other component internal to the device 100.

The cylinder 704 envelopes the baseplate 716. The cylinder defines an opening 114 through which a tablet computer 114 or other wireless devices slides down the slide 702, through the dispenser 112 and into the control of a user when the carousel 700 is rotated by the DPD.

In various embodiments, the opening 714 is covered with a door or other obstruction, which is mechanically activated when the carousel 700 is rotated to dispense the wireless device 114 down the slide 702.

The baseplate 716, partitions 708, slots 710, and wireless devices 114 rotate within the cylinder 704.

The baseplate 716, in the shown embodiment, is convex such that the tablet computer 114 slide with gravity out of the opening 714 when the carousel 700 is rotated exposing the slot 712 warehousing the tablet computer 114 to the opening 714. In other embodiments, the baseplate is planar or concave and pushed out with a mechanical arm using means known to those of skill in the art.

In various embodiments, the baseplate 716, partitions 708, cylinder 704, slide 702, and/or gear 706 are fabricated from metal, alloy, elastomeric materials, fiberglass, wood, or with other materials as known to those of skill in the art.

The gear 706 engages a corresponding gear affixed to an electric motor, the electric motor operating to turn the carousel 700 clockwise or counterclockwise in accordance with instruction of a DPD.

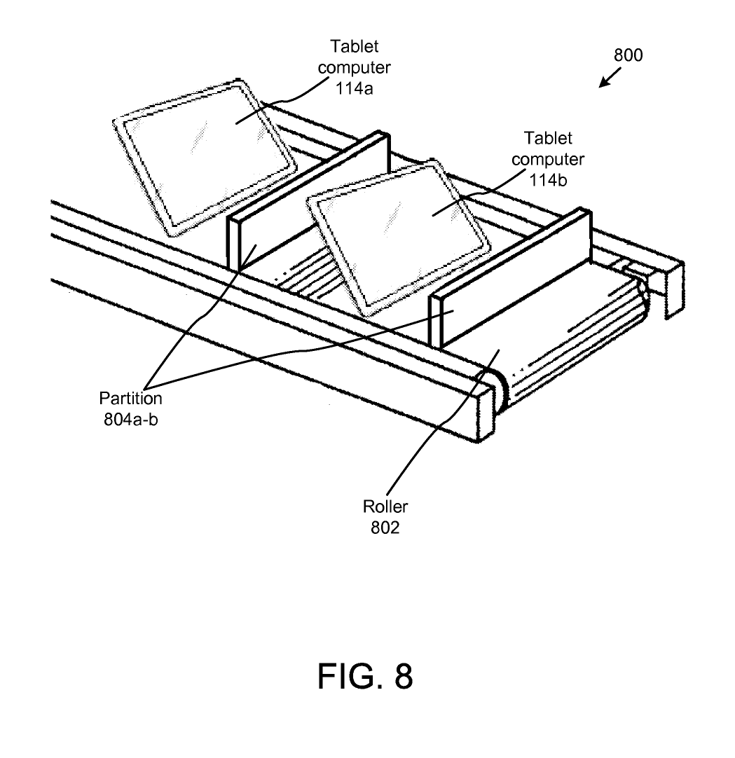

FIG. 8 is an upper perspective view of a roller 800 for warehousing and dispensing wireless 114 in accordance with the present invention.

The roller 800 is internal to the device 100 in some embodiments. The roller 800 warehouses wireless devices 114; and, upon electronic instruction of a DPD, dispensing them as the roller 800 is electronically activated. In some embodiments, this DPD is the wireless router 504 or other component internal to the device 100.

Wireless devices 114a-c are stored on the roller 802, separated by partitions 804a-b. As the roller 802 rolls forward a predetermined distance, the roller 802 and partitions 804a-b push the wireless devices 114a-b forward. The tablet computer 114b falls off the distal (or forward) end of the roller 802, down a slide 702, and is dispensed to a user via the dispenser 112.

In various embodiments of the present invention, the device 100 comprises a plurality of rollers 800.

The systems, methods and apparati correspond generally to other systems, methods, apparati and computer program products outlined in the present invention, but further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for dispensing rented wireless devices to customers, the device comprising:
a housing securely enclosing operational electronic components of the device during unattended operation in a commercial setting;
a graphical user interface (GUI or “display”) for interfacing with a customer;
an internal carousel for warehousing wireless devices in logical connection with the device via a local area network (LAN);
a wireless router for facilitating network communication and relaying encrypted TCP/IP packets to the wireless devices on the LAN, the wireless router connected to, and identified by, an IP address on the Internet;
an electromechanical dispenser for dispensing wireless devices to customers;
an electromechanical retriever for receiving wireless devices returned by a customer to the device;
a plurality of dispensable wireless devices housed within the housing;
a card swipe for scanning credit cards of customers;
a processor; and
a data storage means for storing data.

2. The apparatus of claim 1, wherein the carousel further comprises:
a convex baseplate;
a plurality of partitions affixed to an upper surface of the convex baseplate, the partitions defining one or more slots for warehousing a wireless device; and
a cylinder enveloping the baseplate, the cylinder defining an opening for dispensing wireless devices.

3. The apparatus of claim 1, further comprising a slide for carrying wireless devices from the carousel to the dispenser.

4. The apparatus of claim 1, further comprising pushbutton controls for customer interface with the device.

5. The apparatus of claim 1, wherein the device comprises a kiosk.

6. The apparatus of claim 1, further comprising signage for advertising features and pricing to potential customers.

7. The apparatus of claim 1, further comprising:
a database server comprising a processor and a memory device, the database server configured to store executable and operational data, the memory device comprising:
an registration module configured to registered a customer into a virtual structure controlled by a central authority;
an accessor module configured to electronically access registration information for a customer via the Internet, said registration information accessible only through a grant of permission of from a central authority, said registration information structured in one or more computer readable files and comprising all of name, email, payment information, and historical history evidencing wireless devices previously rented;
a payment module configured to accept electronic payment of the override;
a dispenser module configured to dispense the wireless device the customer and record in computer readable memory one or more of: the serial number of the rented wireless device, the MAC address of the rented wireless device, and the IP address of the rented wireless device;
a retriever module configured to retrieve a wireless device inserted by the customer into the retriever, and to verify the wireless device retrieved is the wireless device previously dispensed to the customer and that the retrieved wireless device is in good working condition;
a transmitter module configured to transmit notice of the rental by the customer to the central authority.

8. The apparatus of claim 5, further comprising a communication module configured to email third-parties employers of the customer with invoicing and promotional information.

9. The apparatus of claim 1, wherein the fees charged to the customer are commiserate with the credit rating of the customer.

10. The apparatus of claim 1, wherein the housing is affixed to a plurality of casters on its undersurface.

11. A device for dispensing rented wireless devices to customers, the device comprising:
a housing securely enclosing operational electronic components of the device during unattended operation in a commercial setting;
a graphical user interface (GUI or “display”) for interfacing with a customer;
an internal roller comprising a plurality of partitions rising orthogonally from a surface of a flexible roller, the partitions defining one or more slot(s) for warehousing the wireless devices in logical connection with the device via a local area network (LAN);
a wireless router for facilitating network communication and relaying encrypted TCP/IP packets to the wireless devices on the LAN, the wireless router connected to, and identified by, an IP address on the Internet;
an electromechanical dispenser for dispensing wireless devices to customers;
an electromechanical retriever for receiving wireless devices returned by a customer to the device;
a plurality of dispensable wireless devices housed within the housing;
a card swipe for scanning credit cards of customers;
a processor; and
a data storage means for storing data.

12. The apparatus of claim 11, wherein the carousel further comprises:
a convex baseplate;
a plurality of partitions affixed to an upper surface of the convex baseplate, the partitions defining one or more slots for warehousing a wireless device; and
a cylinder enveloping the baseplate, the cylinder defining an opening for dispensing wireless devices.

13. The apparatus of claim 11, further comprising a slide for carrying wireless devices from the carousel to the dispenser.

14. A system to dispense and retrieve rented wireless devices, the system comprising:
a processor;
a data storage means for storing data;
a relational database management system (RDBMS);
a GUI;
a plurality of wireless devices housing within a housing comprising the RDBMS and processor;
an registration module configured to registered a customer into a virtual structure controlled by a central authority;
an accessor module configured to electronically access registration information for a customer via the Internet, said registration information accessible only through a grant of permission of from a central authority, said registration information structured in one or more computer readable files and comprising all of name, email, payment information, and historical history evidencing wireless devices previously rented;
a payment module configured to accept electronic payment of the override;
a dispenser module configured to dispense the wireless device the customer and record in computer readable memory one or more of: the serial number of the rented wireless device, the MAC address of the rented wireless device, and the IP address of the rented wireless device;
a retriever module configured to retrieve a wireless device inserted by the customer into the retriever, and to verify the wireless device retrieved is the wireless device previously dispensed to the customer and that the retrieved wireless device is in good working condition;
a transmitter module configured to transmit notice of the rental by the customer to the central authority.

15. The system of claim 16, wherein customers preregister for use of the device on a website maintained by the central authority before interfacing with the device.
